(19) United States
(12) Patent Application Publication
(10) Pub. No.: US 2016/0180271 A1
(43) Pub. Date: Jun. 23, 2016

(54) METHOD FOR PROVIDING INFORMATION VIA A COMPUTER SYSTEM FOR EVALUATING SUITABILITY OF A FIELD DEVICE OF THE PROCESS INDUSTRY FOR A CERTAIN APPLICATION

(71) Applicant: Endress + Hauser Flowtec AG, Reinach (CH)

(72) Inventor: Harald Freimark, Lorrach (DE)

(21) Appl. No.: 14/968,974

(22) Filed: Dec. 15, 2015

(30) Foreign Application Priority Data
Dec. 17, 2014 (DE) 10 2014 118 849.7

(51) Int. Cl. G06Q 10/06; G06Q 30/02

(52) U.S. Cl. CPC G06Q 10/06313; G06Q 30/0282

(57) ABSTRACT

A method for providing information via a computer system for evaluating suitability of a field device of the process industry for a certain application, characterized by steps as follows:
a) indicating the application by inputting the measured substance and, in given cases, further properties of the measured substance;
b) indicating and/or ascertaining a field device type, which is to be considered for the application;
c) providing a database, in which at least one or more evaluations are furnished with reference to one or more on-site reviews of a field device of the input field device type in the indicated application;
d) retrieving the evaluation in the database and
e) outputting the evaluation relative to the indicated field device in the indicated application.

The present invention relates to method for providing information via a computer system, as such method is defined in the preamble of claim 1.

Field devices are usually matched to the measured substance. In spite of specifying the measured substance, however, different field devices can be suited for the application, wherein probability of failure is an important factor for the respective use of the measuring device.

There are applications, for which for different reasons a field device is rather seldom sold. Often, a number of field device types are suited for an application. The question of probability of failure or accuracy of measurement is also a deciding buy criterion in the case of rare, special applications. For achieving a time efficient consultation, be it on-site or by telephone, information relative to the suitability of individual field devices should be rapidly available.

An object of the present invention is the fast providing of information relative to the suitability of a field device for a specified application.

The invention achieves this object by a method as defined in claim 1.

According to the invention, a method for providing information via a computer system for evaluating suitability of a field device of the process industry for a certain application includes steps as follows:
a) indicating the application by inputting a measured substance and, in given cases, further properties of the measured substance;
b) indicating and/or ascertaining a field device type, which is to be considered for the application;
c) providing a database, in which at least one or more evaluations are furnished with reference to one or more on-site reviews of a field device of the indicated and/or ascertained field device type in the indicated application;
d) retrieving the evaluation in the database and
e) outputting the evaluation relative to the indicated or ascertained field device type in the indicated application.

Advantageous embodiments of the method are subject matter of the dependent claims.

The additional properties of the measured substance can advantageously be selected from the pressure and/or the temperature of the measured substance.

The evaluation can be furnished as a grading of the functional ability of the field device in the respective application. A typical valuation is e.g.
field device defective—grade 6
field device measures inaccurately—grade 5
field device measures, however, problems are caused by attack of the substance (e.g. some lack of sealing)—grade 4
field device measures within the device specification, no deficiencies detectable, however, calibration provided higher accuracy—grade 3
field device measures exactly, however, specifications require regular maintenance—grade 2
field device measures exactly and needs no, or only irregular, maintenance—grade 1

It is advantageous, when, supplementally to the evaluation, one or more service protocols are stored in the database, to which the evaluation points. This is especially advantageous, in order to reconstruct, in greater detail, an unusual, short evaluation of a service event. Thus, if a device failed before this service, the service protocol can show how the ultimate defect was finally removed. Since then, no further defect has occurred. The cause of the defect and its solution can in such cases be understood from the service protocol.

It is advantageous when an output includes a plurality of field devices of different field device types with the respectively associated evaluations, thus a total evaluation of field device types in the indicated application, or the respectively associated evaluations, thus the individual evaluations for each installed field device in the indicated application. In this way, a user can compare the different field device types, which are candidates for the application.

It is advantageous, when the number of conducted on-site reviews is given supplementally to the evaluation. In this way, it can be detected by how many events, respectively short evaluations, the particular individual evaluation is supported.

It is additionally advantageous, when the number of field devices of same field device type reviewed in the application by on-site investigations is given. From this the significance of the total evaluation can be estimated, since it makes a difference whether so far only three or fifty field devices have been sold for this application.

The output according to step e) can advantageously occur in such a manner that a plurality of field devices of different field device types and their evaluations for the indicated application are displayed.

A computer program product of the invention, in which the steps of the method as claimed in claim 1 are implemented, conducts a processing of the indicated and/or ascertained field device type and the indicated application by comparison of data of a database of the indicated or ascertained field device type and assigns to the field device type an evaluation for the indicated application.

Contained in the database for each field device type as a function of application are individual field devices, which are applied for measuring the predetermined measured substance, in given cases, for predetermined properties such as pressure and temperature of the measured substance.

The method of the invention will now be explained in greater detail based on two examples of embodiments as schematically presented in the appended drawing, the figures of which show as follows:

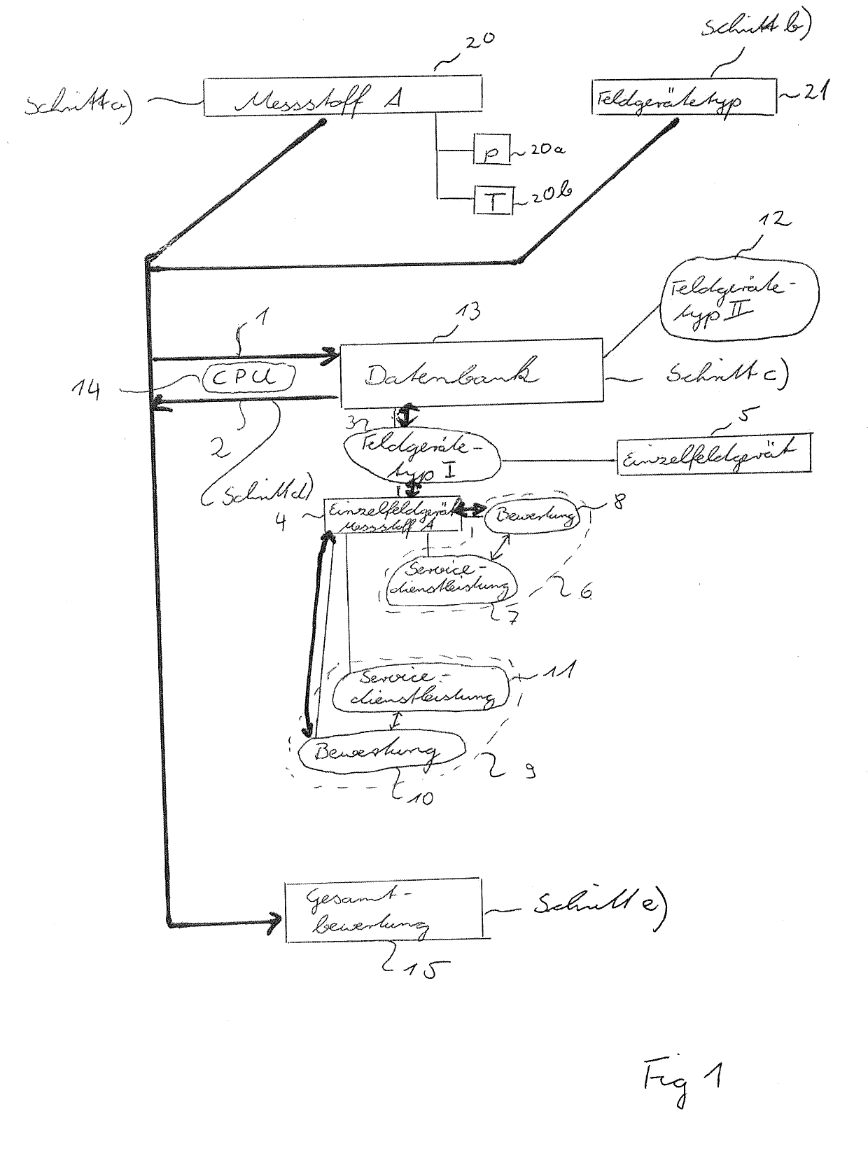

FIG. 1 flow diagram of a first example of an embodiment of a method of the invention; and

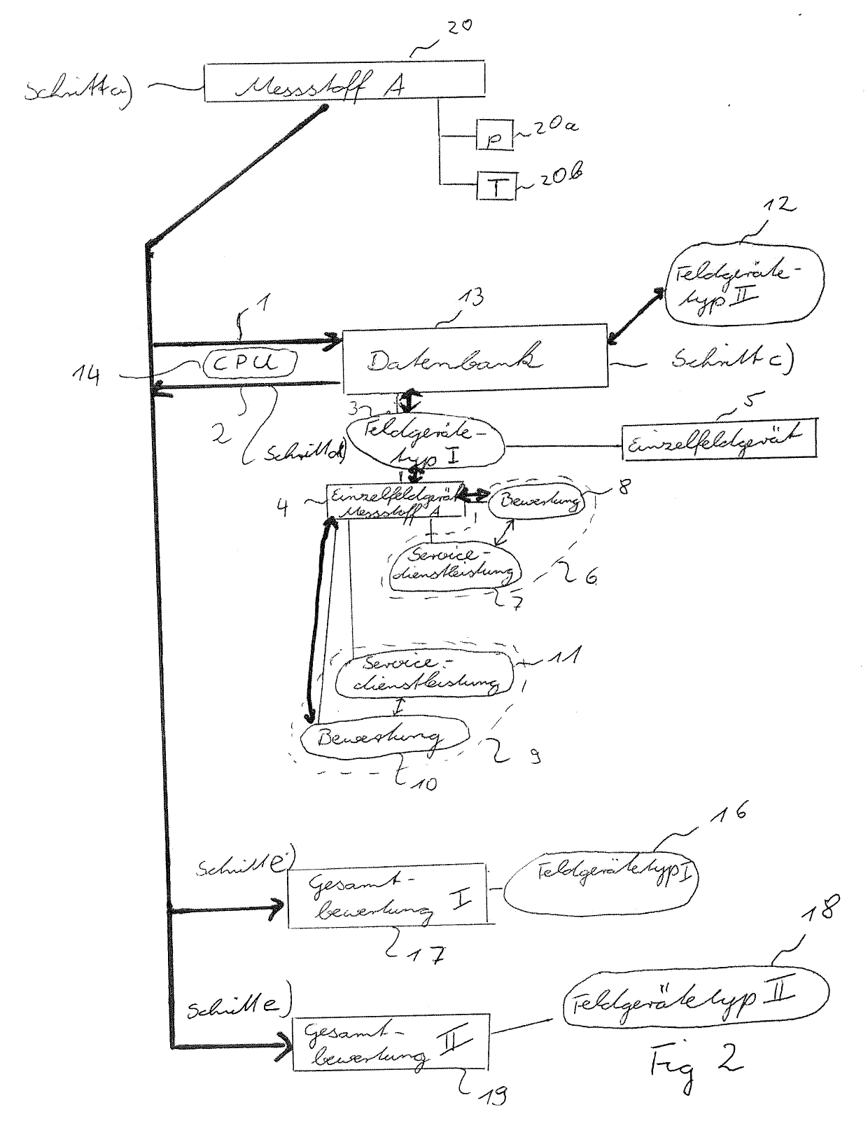

FIG. 2 flow diagram of a second example of an embodiment of a method of the invention.

In automation technology, especially in process automation technology, field devices are often applied, which serve for registering and/or influencing process variables. Serving for registering process variables are sensors, which are integrated, for example, in fill level measurement devices, flow measuring devices, pressure- and temperature measuring devices, pH redox-potential measuring devices, conductivity measuring devices, etc., which register the corresponding process variables, fill level, flow, pressure, temperature, pH-value, redox potential, and conductivity, respectively. Serving for influencing process variables are actuators, such as, for example, valves or pumps, via which the flow of a liquid in a pipeline section, respectively the fill level in a container, can be changed. Referred to as field devices are, in principle, all devices, which are applied near to the process and deliver, or process, process relevant information. In connection with the invention, the terminology, field devices, means, thus, also remote I/Os, radio adapters, respectively, generally electronic components, which are arranged on the field plane. A large number of such field devices are produced and sold by the firm, Endress+Hauser. A field device, is, in such case, especially selected from a group composed of flow measuring devices, fill-level measuring devices, pressure measuring devices, temperature measuring devices, limit level measuring devices and/or analytical measuring devices.

Flow measuring devices include, especially, Coriolis-, ultrasonic, vortex-, thermal and/or magneto inductive, flow measuring devices. Fill level measuring devices include, especially, microwave, fill level measuring devices, ultrasonic, fill level measuring devices, time domain reflectometric, fill level measuring devices (TDR), radiometric, fill level measuring devices, capacitive, fill level measuring devices, inductive, fill level measuring devices and/or temperature sensitive, fill level measuring devices.

Pressure measuring devices include, especially, absolute-, relative- or difference pressure measuring devices.

Temperature measuring devices include, especially, measuring devices with thermocouples and temperature dependent resistors. Limit level measuring device, include, especially, vibronic, limit level measuring device, ultrasonic, limit level measuring device and/or capacitive, limit level measuring device. Analytical measuring devices include, especially, pH sensors, conductivity sensors, oxygen- and active oxygen sensors, (spectro)-photometric sensors, and/or ion-selective electrodes

For a more efficient customer advising, e.g. on-site, and for better overview of the application-specific problem statement, a method should be provided, which outputs an evaluation of field device types for a certain application and makes this available e.g. to a customer or to a customer advisor.

To the extent that a field device was sold for an application, in many cases, provisions of service are necessary. In such case, these can concern calibration services, repair services, maintenance services and/or a replacement of the field device. In the case of these provisions of service, most often, a service protocol is created concerning the functional ability of the field device and logged according to date and in short or at length concerning the details of the provision of service.

This information relative to the provisions of service to a field device in the specific application lie, however, most often in written form in a database and are, however, most often, only retrievable with increased search effort. Additionally, the service information is, most often, extensive and, consequently, exploitable only with increased time consumed. With the method of the invention, an opportunity for linking this service information is given, so that information for the sale or for an error analysis is faster retrievable from the database.

A method of the invention for providing information concerning a computer system for evaluating suitability of a field device of the process industry for a certain application s characterized by steps as follows:
a) indicating the application by indicating the measured substance and, in given cases, further properties of the measured substance;
b) indicating and/or ascertaining a field device type which is to be considered for the application;
c) providing a database, in which at least one or more evaluations are furnished with reference to one or more on-site reviews of a field device of the indicated or ascertained field device type in the indicated application;
d) retrieving the evaluation in the database and
e) outputting the evaluation relative to the indicated or ascertained field device type in the indicated application.

The step sequence of the method steps can vary and are not absolutely fixed to the sequence a-e).

The concept “computer system” in the sense of the present invention is to be broadly construed. A computer system includes both cell phones, laptops, tablet-PC's, PCs, Pocket-PCs and systems linked with one another.

The indicating of the application in step a) includes at least indicating, respectively inputting, the measured substance. In the concrete case of FIGS. 1 and 2, of concern is a measured substance A. This is shown in FIGS. 1 and 2 by the input box 20. Additionally, also properties such as pressure and temperature of the measured substance can be entered in the input boxes 20a and 20b. The input can, thus, supplementally, contain other data relative to the properties of the measured substance, especially temperature and pressure. A typical indicating is, for example, the inputting of hydrochloric acid at 45° C. and 3 bar. The indicating of the measured substance and the additional properties can occur in a search form presented on a computer screen.

The indicating of a field device type can occur in step b) FIG. 1 by input into the computer system. In such case, only the indicating of the field device type, e.g. magneto-inductive, flow measuring device, can occur, or, however, especially preferably, the indicating of the field device type in a certain structural embodiment, e.g. magneto-inductive, flow measuring device with ceramic liner, can be given. For this, an input box 21 is provided, which individually or together with the input boxes 20, 20a and 20b can be displayed by an output unit of a computer system.

The providing of the database 13 in step c) occurs via the computer system. The computer system includes, in such case, a central computing unit 14, a CPU, which manages the database and evaluates data of the database. The database can be stored both on a server as well as also on a hard disk. It is preferably also managed and updated by the computer system.

Stored in the database are preferably both service protocols 7 of the provision of service as well as also, in each case, a short evaluation 8 concerning the respective provisions of service. The evaluation, respectively short evaluation, 8, and the particular provision of service point to one another and are associated with one another. It is possible, however, also to furnish only the short evaluation 8. The service protocols 7 and the short evaluations 8 reference a transpired, on-site review of the field device in the context of a provision of service.

The retrieving of the evaluation in the database according to step d) occurs by transmitting the input data relative to the measured substance and, in given cases, also the indicated field device type.

Thereafter, all data sets 6, 7, which refer to on-site-review of all individual field devices 4, 5 of all field device types, which are applied for measuring the measured substance, are identified. A particular field device type designation is not necessary, since such is ascertained from the database search. This case is shown in FIG. 2.

It is, however, also possible, already to specify a field device type and a corresponding measured substance. In this case, there occurs only the ascertaining of the individual field devices 4, which are applied for measuring the specific measured substance A, and the retrieval of the service related short evaluations 8, 10, and, in given cases, the service protocols 7, 11.

Such can occur by retrieving the respective short evaluations 8 for each individual field device, here individual field device 4, individual field device 5, . . . . In this case, the evaluation furnished in the database corresponds to the queried and output evaluation.

For improving perspicuity of the information to be provided, it is helpful, however, to bring together the short evaluations of all field devices of the same field device type into a total evaluation 15, 17, 19. In the case of output of a plurality of total evaluations 17, 19, it is helpful to indicate the field device types 16, 18, to which the total evaluations relate.

The ascertaining of the total evaluation of a field device type can occur based on the evaluations, respectively short evaluations, furnished in the database, e.g. by means of the CPU 14. A short evaluation can be formed e.g. by furnishing numerical values or color codes. By combining the short evaluations, the computer system can output an individual evaluation of a particular field device for the application. This can occur e.g. by forming the arithmetic average of the individual short evaluations or by weighted averaging of the short evaluations. This is, of course, only one of many opportunities for ascertaining an individual evaluation from all short evaluations, which are furnished in the database as a result of performed provisions of service for the applied device.

The individual evaluations of all field devices of a respective field device type are then combined to a total evaluation of the field device type for the indicated application.

This total evaluation of the field device type can be ascertained in the case of each updating of the database and be present in the system already at the time of query or only be ascertained when the query is made. This total evaluation is then output in step e) to the user. This can occur e.g. via a display to a customer, a customer advisor, etc.

Along with that, the method also enables finding critical applications, in which a continuous need of improvement of field device types is necessary. By additional furnishing of evaluations concerning device state and exploitation of the evaluations, provisions of service can be utilized for evaluating use of the field device in a specific application.

FIG. 2 shows another advantageous variation of the method. In FIG. 2, only the input of the measured substance occurs. Then, the computer system ascertains, for which field device types and/or which embodiments of field device types there are already evaluations for the indicated application present in the database. These field device types are, thus, not predetermined by the user, but, instead, are ascertained by the computer system.

Then, analogously to FIG. 1, a total evaluation concerning all stored field devices of each individual field device type, which is utilized in the indicated application, can be created and these field device types and the associated evaluations output as regards suitability for the indicated application.

### LIST OF REFERENCE CHARACTERS

1 input data

2 output data

3 data set (field device type I)

4 sub-data set (individual field device)

5 sub-data set (individual field device)

6 data combination (provision of service+evaluation)

7 data (provision of service)

8 data (evaluation)

9 data combination (provision of service+evaluation)

10 data (provision of service)

11 data (evaluation)

12 data set (field device type II)

13 database

14 computing unit

15 output value (total evaluation—field device type I)

16 name (field device type I)

17 output value (total evaluation)

18 name (field device type I)

19 output value (total evaluation)

20 input value (measured substance)

21 input value (field device type)

20a pressure of the measured substance

20b temperature of the measured substance

1. Method for providing information via a computer system for evaluating suitability of a field device of the process industry for a certain application, characterized by steps as follows:
a) indicating the application by inputting a measured substance and, in given cases, further properties of the measured substance;
b) indicating and/or ascertaining a field device type, which is to be considered for the application;
c) providing a database, in which at least one or more evaluations are furnished with reference to one or more on-site reviews of a field device of the indicated or ascertained field device type in the indicated application;
d) retrieving the evaluation in the database, and
e) outputting the evaluation relative to the indicated and/or ascertained field device type in the indicated application.

2. Method as claimed in claim 1, characterized in that the retrieving of the evaluation occurs by ascertaining a total evaluation of the field device type from individual evaluations of all field devices of the same field device type, which are furnished in the database for the indicated application.

3. Method as claimed in claim 1, characterized in that the additional properties of the measured substance are selected from pressure and/or temperature of the measured substance.

4. Method as claimed in claim 1, characterized in that the evaluation is furnished as a grading of the functional ability of the field device.

5. Method as claimed in claim 1, characterized in that, supplementally to the evaluation, one or more service protocols is/are stored in the database, to which the evaluation points.

6. Method as claimed in claim 1, characterized in that a plurality of evaluations are present or an evaluation is composed of a number of partial evaluations, wherein, in each case, an evaluation and/or partial evaluation is associated with a service protocol.

7. Method as claimed in claim 1, characterized in that an output of a plurality of field devices of different field device types occurs with the respectively associated evaluation or evaluations for the indicated application.

8. Method as claimed in claim 1, characterized in that the number of conducted on-site reviews is given supplementally to the evaluation.

9. Method as claimed in claim 1, characterized in that the number of field devices of same field device type reviewed in the application by on-site investigations is given.

10. Method as claimed in claim 1, characterized in that the output according to step e) occurs in such a manner that a plurality of field devices of different field device type and their evaluations for the indicated application are displayed.

11. Computer program product, characterized in that the computer program product conducts according to the method as claimed in claim 1 a processing of the indicated field device type and the indicated application by comparing data of a database and associates an evaluation for the indicated application with a field device of the indicated field device type.
